(19) United States
(12) Patent Application Publication
(10) Pub. No.: US 2017/0103569 A1
(43) Pub. Date: Apr. 13, 2017

(54) OPERATOR INTERFACE FOR 3D SURFACE DISPLAY USING 2D INDEX IMAGE

(71) Applicant: Carestream Health, Inc., Rochester, NY (US)

(72) Inventors: Yingqian Wu, Shanghai (CN); Yu Zhou, Shanghai (CN); Menghui Guan, Shanghai (CN); Qinran Chen, Shanghai (CN)

(21) Appl. No.: 14/967,839

(22) Filed: Dec. 14, 2015

Related U.S. Application Data
(60) Provisional application No. 62/238,760, filed on Oct. 8, 2015.

(51) Int. Cl. G06T 17/10; G06T 15/04

(52) U.S. Cl. CPC G06T 17/10; G06T 15/04

(57) ABSTRACT

A method for display of a region of interest of a 3D tooth surface forms a 3D surface model using a number of structured light images, then forms a global texture map for the 3D surface model according to a plurality of reflectance images of the teeth. The 2D image is generated and displayed using the 3D surface model. Pixels in mesh elements of the 2D index image have corresponding surface facets of the 3D surface model. The method describes Identifying and rendering the region of interest in response to viewer instructions.

### CROSS REFERENCE TO RELATED APPLICATIONS

This application claims the benefit of U.S. Provisional application U.S. Ser. No. 62/238,760, provisionally filed on Oct. 8, 2015, entitled “OPERATOR INTERFACE FOR 3D SURFACE DISPLAY USING 2D INDEX IMAGE”, in the names of Yingqian Wu, Yu Zhou, Menghui Guan and Qinran Chen, which is incorporated herein by reference in its entirety.

### FIELD OF THE INVENTION

The invention relates generally to the field of surface shape imaging and more particularly relates to apparatus and methods for display of 3D surface features indexed to a 2D panorama image.

### BACKGROUND

Structured light imaging is one familiar technique that has been successfully applied for surface characterization. In structured light imaging, a pattern of illumination is projected toward the surface of an object from a given angle. The pattern can use parallel lines of light or more complex periodic features, such as sinusoidal lines, dots, or repeated symbols, and the like. The light pattern can be generated in a number of ways, such as using a mask, an arrangement of slits, interferometric methods, or a spatial light modulator, such as a Digital Light Processor from Texas Instruments Inc., Dallas, Tex. or similar digital micromirror device. Multiple patterns of light may be used to provide a type of encoding that helps to increase robustness of pattern detection, particularly in the presence of noise. Light reflected or scattered from the surface is then viewed from another angle as a contour image, taking advantage of triangulation in order to analyze surface information based on the appearance of contour lines or other patterned illumination.

Structured light imaging has been used effectively for surface contour imaging of solid, highly opaque objects and has been used for imaging the surface contours for some portions of the human body and for obtaining detailed data about skin structure. Structured light imaging methods have also been applied to the problem of dental imaging, helping to provide detailed surface information about teeth and other intraoral features. Intraoral structured light imaging is now becoming a valuable tool for the dental practitioner, who can obtain this information by scanning the patient's teeth using an inexpensive, compact intraoral scanner, such as the Model CS3500 Intraoral Scanner from Carestream Dental, Atlanta, Ga.

Contour imaging uses patterned or structured light to obtain surface contour information for structures of various types. In structured light projection imaging, a pattern of lines or other shapes is projected toward the surface of an object from a given direction. The projected pattern from the surface is then viewed from another direction as a contour image, taking advantage of triangulation in order to analyze surface information based on the appearance of contour lines. Phase shifting, in which the projected pattern is incrementally spatially shifted for obtaining images that provide additional measurements at the new locations, is typically applied as part of structured light projection imaging, used in order to complete the contour mapping of the surface and to increase overall resolution in the contour image.

The advent of less expensive video imaging devices and advancement of more efficient contour image processing algorithms now make it possible to acquire structured light images without the need to fix the scanner in position for individually imaging each tooth. With upcoming intraoral imaging systems, it can be possible to acquire contour image data by moving the scanner/camera head over the teeth, allowing the moving camera to acquire a large number of image views that can be algorithmically fitted together and used to for forming the contour image.

Although textured 3D contour imaging of the teeth can provide a significant amount of useful information on tooth condition as well as overall structure and appearance, there can be practical problems that hamper the effective use of 3D display capabilities in some cases. In order to observe details from the 3D tooth model that is constructed, the practitioner may need to alter the 3D view position as well as making pan, zoom, and scale adjustments. Providing a suitable close-up view of the portion of the dental arch that is of interest can be particularly difficult during a procedure, since this typically involves some fairly complex interaction with the 3D mesh that has been generated and displayed on the system monitor. Even with interface tools such as a positioning glove or wand, direct manipulation of the 3D image model can be challenging, especially when the practitioner is actively working on a particular tooth, for example.

Other difficulties relate to the need to edit the 3D model. The capability to edit the 3D surface is a useful feature in a number of applications, including dental restoration and prosthesis implant planning. Among editing functions executed by the practitioner are cutting, trimming, marking, and tagging, for example. It can be cumbersome to manipulate the full 3D mesh for this purpose, such as by rotating, surface displacement, and other operations.

Thus, it can be seen that there would be significant value in a method for imaging system interaction that allows the practitioner to specify 3D content for display and editing in an intuitive manner, without requiring manipulation of the full 3D model on a display screen.

### SUMMARY

An object of the present invention is to advance the art of image content manipulation for 3-D surface image presentation. Embodiments of the present disclosure provide operator interface utilities and methods that can help to streamline and simplify the procedure for identifying, editing, and presenting a portion of a full 3D surface image model to the viewer.

These aspects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a method for display of a region of interest of a 3D tooth surface model, the method comprising:
forming the 3D surface model using a plurality of structured light images;
forming a global texture map for the 3D surface model according to a plurality of reflectance images of the teeth;
generating and displaying a 2D index image from the 3D surface model,
wherein pixels in the mesh elements of the 2D index image correspond to surface facets of the 3D surface model;
and
identifying and rendering the region of interest in response to viewer instructions.

### BRIEF DESCRIPTION OF THE DRAWINGS

The foregoing and other objects, features, and advantages of the invention will be apparent from the following more particular description of the embodiments of the invention, as illustrated in the accompanying drawings.

The elements of the drawings are not necessarily to scale relative to each other. Some exaggeration may be necessary in order to emphasize basic structural relationships or principles of operation. Some conventional components that would be needed for implementation of the described embodiments, such as support components used for providing power, for packaging, for interconnection to transmit signal content between components, and for mounting and protecting system optics, for example, are not shown in the drawings in order to simplify description.

FIG. 1 is a schematic diagram that shows components of an imaging apparatus for surface contour imaging of a patient's teeth and related structures.

FIG. 2 shows schematically how patterned light is used for obtaining surface contour information using a handheld camera or other portable imaging device.

FIG. 3 shows an example of surface imaging using a pattern with multiple lines of light.

FIG. 4 is a logic flow diagram that shows a sequence for rendering a region of interest from a surface model of a tooth.

FIG. 5 shows a portion of an exemplary mesh formed from a point cloud.

FIG. 6 shows components of a global texture map for the tooth model.

FIG. 7 shows the textured tooth surface for a portion of the tooth model.

FIG. 8 shows an exemplary parameterized 2D mesh formed from the 3D mesh data.

FIG. 9 shows a 2D index image corresponding to a tooth surface from the surface model.

FIG. 10 shows an exemplary operator interface that uses a 2D index image for specifying an ROI from a tooth surface model for display.

FIG. 11 is a logic flow diagram that shows steps executed following editing by the practitioner or other user.

FIG. 12A shows a typical 2D index image for a portion of the dental arch.

FIG. 12B shows a corresponding portion of tooth surface model as rendered on the display screen by the system computer processor.

### DETAILED DESCRIPTION OF EXEMPLARY EMBODIMENTS

The following is a detailed description of the preferred embodiments, reference being made to the drawings in which the same reference numerals identify the same elements of structure in each of the several figures.

Where they are used in the context of the present disclosure, the terms “first”, “second”, and so on, do not necessarily denote any ordinal, sequential, or priority relation, but are simply used as labels to more clearly distinguish one step, element, or set of elements from another and are not intended to impose numerical requirements on their objects, unless specified otherwise.

As used herein, the term “energizable” relates to a device or set of components that perform an indicated function upon receiving power and, optionally, upon receiving an enabling signal.

In the context of the present disclosure, the terms “structured light illumination”, “fringe pattern”, or “patterned illumination” are used to describe the type of illumination that is used for structured light projection imaging or “contour” imaging that characterizes tooth shape. The structured light pattern itself can include, as patterned light features, one or more lines, circles, curves, or other geometric shapes that are distributed over the area that is illuminated and that have a predetermined spatial and temporal frequency. One exemplary type of structured light pattern that is widely used for contour imaging is a pattern of evenly spaced lines of light projected onto the surface of interest.

In the context of the present disclosure, the term “structured light image” refers to the image that is captured during projection of the light pattern or “fringe pattern” that is used for characterizing the tooth contour. “Contour image” and “contour image data” refer to the processed image data that are generated and updated from structured light images.

In the context of the present disclosure, the term “optics” is used generally to refer to lenses and other refractive, diffractive, and reflective components used for shaping and orienting a light beam.

In the context of the present disclosure, the terms “viewer”, “operator”, “editor”, and “user” are considered to be equivalent and refer to the viewing practitioner, technician, or other person who may operate a camera or scanner and may also view and manipulate an image, such as a dental image, on a display monitor. An “operator instruction” or “viewer instruction” is obtained from explicit commands entered by the viewer, such as by clicking a button on the camera or by using a computer mouse or by touch screen or keyboard entry.

The term “set”, as used herein, refers to a non-empty set, as the concept of a collection of one or more elements or members of a set is widely understood in elementary mathematics. The term “subset”, unless otherwise explicitly stated, is used herein to refer to a non-empty proper subset, that is, to a subset of the larger set, having one or more members. For a set S, a subset may comprise the complete set S. A “proper subset” of set S, however, is strictly contained in set S and excludes at least one member of set S.

In the context of the present disclosure, the phrase “in signal communication” indicates that two or more devices and/or components are capable of communicating with each other via signals that travel over some type of signal path. Signal communication may be wired or wireless. The signals may be communication, power, data, or energy signals. The signal paths may include physical, electrical, magnetic, electromagnetic, optical, wired, and/or wireless connections between the first device and/or component and second device and/or component. The signal paths may also include additional devices and/or components between the first device and/or component and second device and/or component.

In the context of the present disclosure, a reflectance image is a conventional 2D image of a subject obtained with the subject illuminated by a field of light. A reflectance image can be monochrome or polychromatic. A polychromatic reflectance image can be obtained using a monochrome sensor with illumination fields of different colors, that is, of different wavelength bands, provided in rapid sequence.

In the context of the present disclosure, the terms “camera” and “scanner” are used interchangeably, as the description relates to structured light images successively projected and captured by a camera device operating in a single-image mode or in a continuous acquisition or video mode.

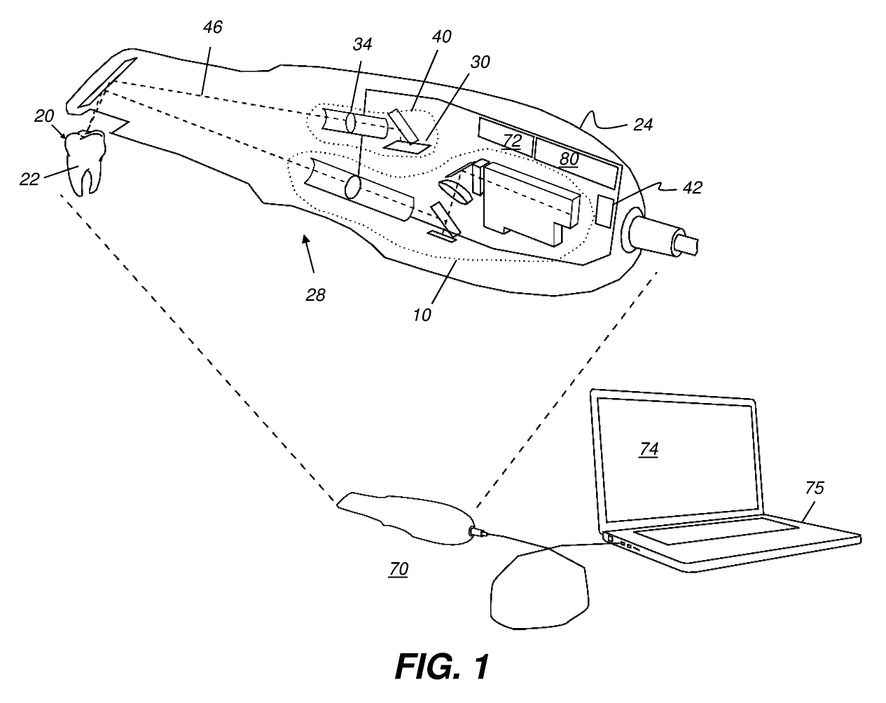

FIG. 1 is a schematic diagram showing an imaging apparatus 70 that operates as a video camera 24 for polychromatic reflectance image data capture as well as a scanner 28 for projecting and imaging functions used to characterize surface contour with structured light patterns 46. A handheld imaging apparatus 70 uses a video camera 24 for image acquisition for both contour scanning and image capture functions according to an embodiment of the present disclosure. A control logic processor 80, or other type of computer that may be part of camera 24, controls the operation of an illumination array 10 that generates the structured light and directs the light toward a surface position and controls operation of an imaging sensor array 30. Image data from surface 20, such as from a tooth 22, is obtained from imaging sensor array 30 and stored as video image data in a memory 72. Imaging sensor array 30 is part of a sensing apparatus 40 that includes an objective lens 34 and associated elements for acquiring video image content. Control logic processor 80, in signal communication with camera 24 components that acquire the image, processes the received image data and stores the mapping in memory 72. The resulting image from memory 72 is then optionally rendered and displayed on a display 74, which may be part of another computer 75 used for some portion of the processing described herein. Memory 72 may also include a display buffer. One or more sensors 42, such as a motion sensor, can also be provided as part of scanner 28 circuitry.

In structured light imaging, a pattern of lines or other shapes is projected from illumination array 10 toward the surface of an object from a given angle. The projected pattern from the illuminated surface position is then viewed from another angle as a contour image, taking advantage of triangulation in order to analyze surface information based on the appearance of contour lines. Phase shifting, in which the projected pattern is incrementally shifted spatially for obtaining additional measurements at the new locations, is typically applied as part of structured light imaging, used in order to complete the contour mapping of the surface and to increase overall resolution in the contour image.

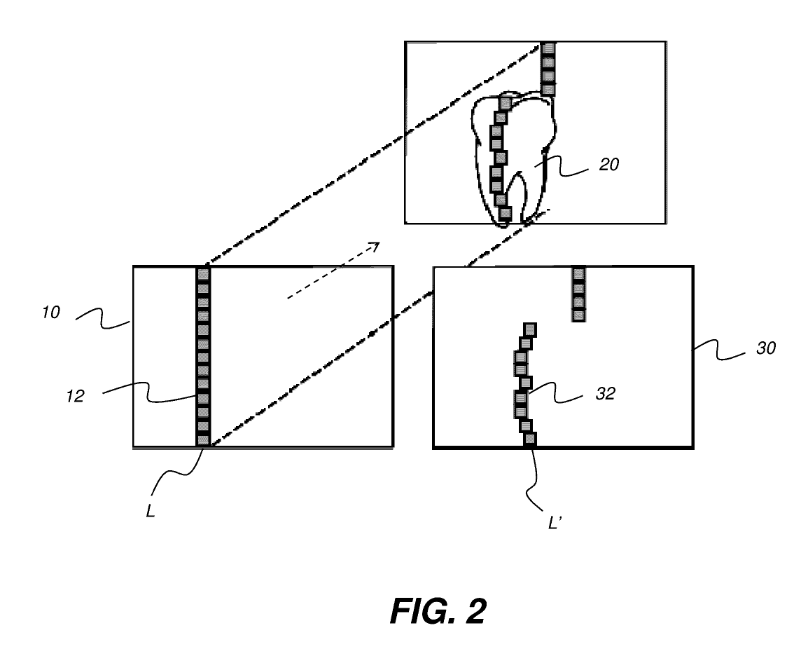

The schematic diagram of FIG. 2 shows, with the example of a single line of light L, how patterned light is used for obtaining surface contour information by a scanner using a handheld camera or other portable imaging device. A mapping is obtained as an illumination array 10 directs a pattern of light onto a surface 20 and a corresponding image of a line L′ is formed on an imaging sensor array 30. Each pixel 32 on imaging sensor array 30 maps to a corresponding pixel 12 on illumination array 10 according to modulation by surface 20. Shifts in pixel position, as represented in FIG. 2, yield useful information about the contour of surface 20. It can be appreciated that the basic pattern shown in FIG. 2 can be implemented in a number of ways, using a variety of illumination sources and sequences for light pattern generation and using one or more different types of sensor arrays 30. Illumination array 10 can utilize any of a number of types of arrays used for light modulation, such as a liquid crystal array or digital micromirror array, such as that provided using the Digital Light Processor or DLP device from Texas Instruments, Dallas, Tex. This type of spatial light modulator is used in the illumination path to change the light pattern as needed for the mapping sequence.

By projecting and capturing images that show structured light patterns that duplicate the arrangement shown in FIG. 1 multiple times, the image of the contour line on the camera simultaneously locates a number of surface points of the imaged object. This speeds the process of gathering many sample points, while the plane of light (and usually also the receiving camera) is laterally moved in order to “paint” some or all of the exterior surface of the object with the plane of light.

A synchronous succession of multiple structured light patterns can be projected and analyzed together for a number of reasons, including to increase the density of lines for additional reconstructed points and to detect and/or correct incompatible line sequences. Use of multiple structured light patterns is described in commonly assigned U.S. Patent Application Publications No. US2013/0120532 and No. US2013/0120533, both entitled “3D INTRAORAL MEASUREMENTS USING OPTICAL MULTILINE METHOD” and incorporated herein in their entirety.

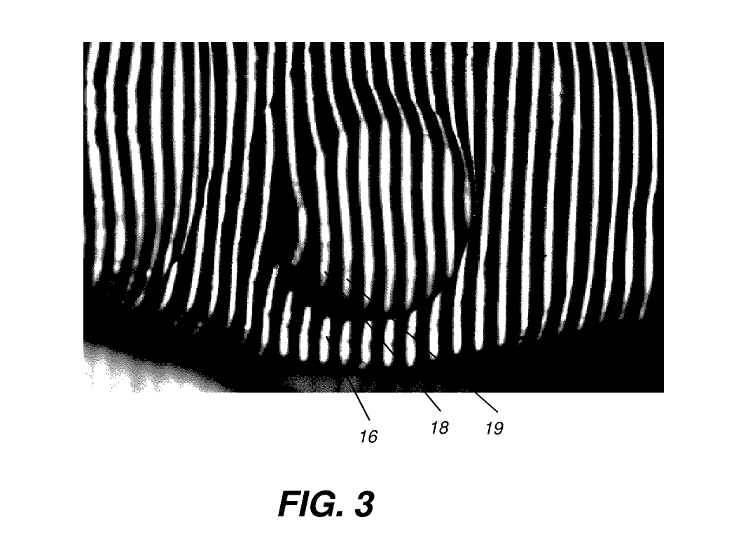

FIG. 3 shows surface imaging using a pattern with multiple lines of light. Incremental shifting of the line pattern and other techniques help to compensate for inaccuracies and confusion that can result from abrupt transitions along the surface, whereby it can be difficult to positively identify the segments that correspond to each projected line. In FIG. 3, for example, it can be difficult over portions of the surface to determine whether line segment 16 is from the same line of illumination as line segment 18 or adjacent line segment 19.

By knowing the instantaneous position of the camera and the instantaneous position of the line of light within a object-relative coordinate system when the image was acquired, a computer and software can use triangulation methods to compute the coordinates of numerous illuminated surface points relative to a plane. As the plane is moved to intersect eventually with some or all of the surface of the object, the coordinates of an increasing number of points are accumulated. As a result of this image acquisition, a point cloud of vertex points or vertices can be identified and used to represent the extent of a surface within a volume. The points in the point cloud then represent actual, measured points on the three dimensional surface of an object. A mesh can then be constructed, connecting points on the point cloud as vertices that define individual congruent polygonal faces (typically triangular faces) that characterize the surface shape. The full 3D image model can then be formed by combining the surface contour information provided by the mesh with polychromatic image content obtained from a camera, such as camera 24 that is housed with camera 24 in the embodiment described with reference to FIG. 1. Polychromatic image content can be provided in a number of ways, including the use of a single monochrome imaging sensor with a succession of images obtained using illumination of different primary colors, one color at a time, for example. Alternately, a color imaging sensor could be used.

As noted previously in the background section, the practitioner can find it difficult to manipulate, view, and edit the full 3D model that is displayed, particularly when carrying out a procedure on a tooth or supporting structure. An embodiment of the present disclosure addresses the need for operator interface tools that simplify viewer procedure for manipulating the display and editing the model, and help to identify and positionally orient a relevant portion of the 3D view needed by the practitioner.

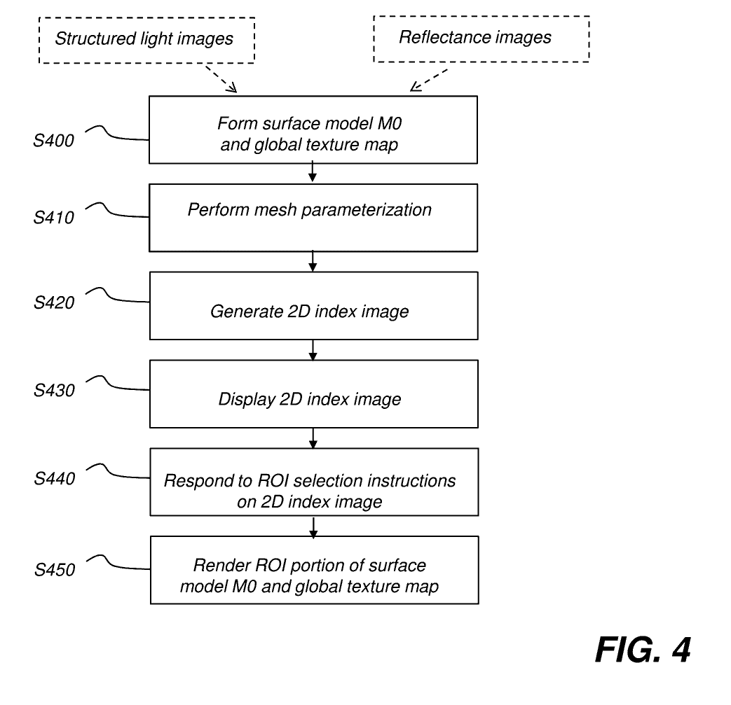

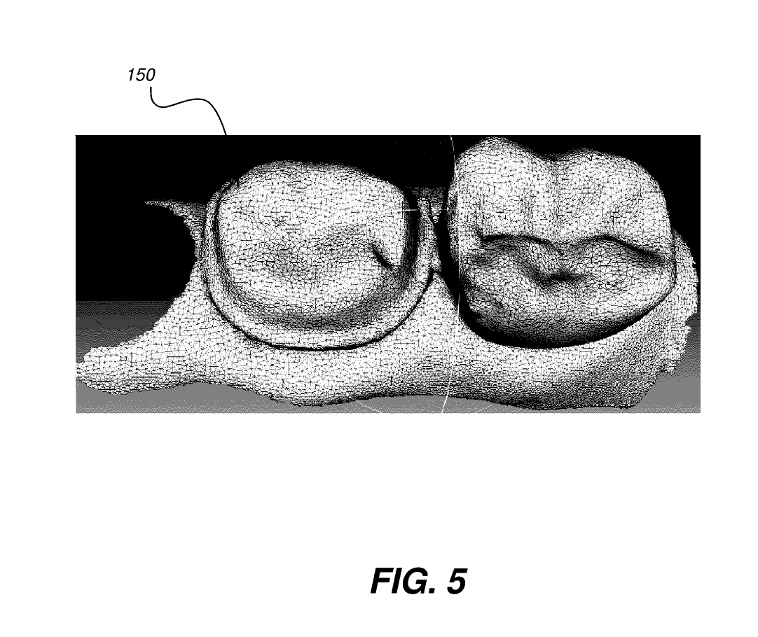

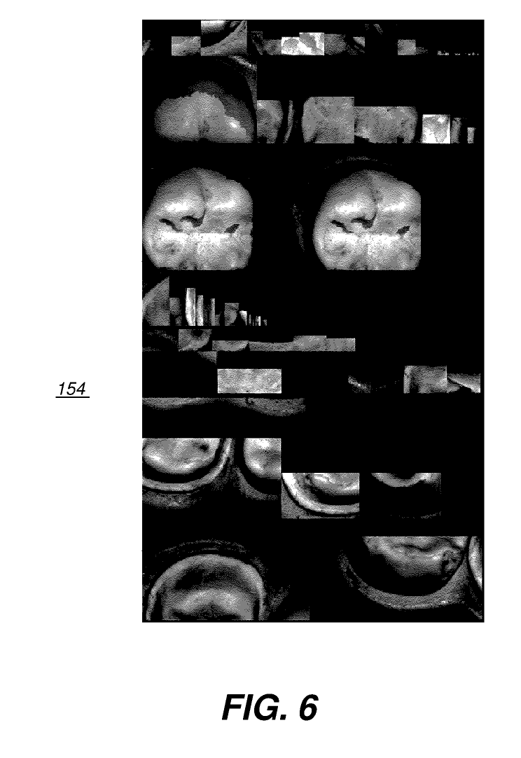

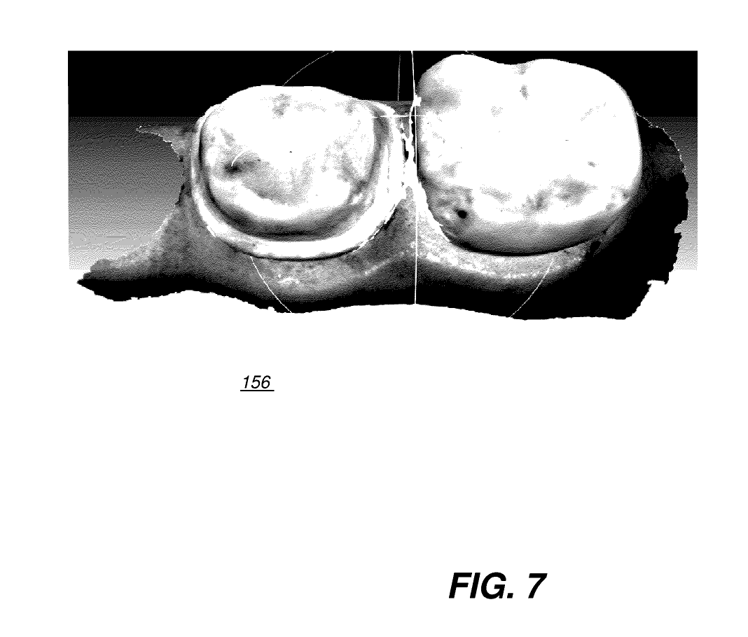

The logic flow diagram of FIG. 4 shows a sequence for display rendering of a region of interest (ROI) from a 3D model, with the sequence executed by a processor apparatus such as computer 75 (FIG. 1) according to an embodiment of the present disclosure. FIGS. 5 through 9 then show examples for the different image types described in FIG. 4. In a surface model data generation step S400, processing forms a surface model M0 of a patient's teeth and supporting structures using combined information from a scanned series of structured light images. Structured light images are used to generate a point cloud from which a mesh is generated, using techniques familiar to those skilled in the 3D surface imaging arts. FIG. 5 shows a portion of an exemplary mesh 150 formed from a point cloud. FIG. 6 shows components of an exemplary global texture map 154 for the tooth model M0. Global texture map 154, formed from a selected number of reflectance images of a patient's teeth, provides surface information used in 3D rendering for more life-like presentation of surface texture. Pixels in the global texture map can be mapped to vertices in the 3D mesh that is generated. FIG. 7 shows the textured tooth surface 156 for a portion of the tooth model.

The final surface of the tooth model is denoted Mo. Tooth model Mo is a mesh structure that has J facets F={F1, F2, . . . FJ} and I vertices V={V1, V2, . . . VI}. Each facet is defined by N vertices, Fk={Vk1, Vk2, . . . , Vkn}. Any vertex, Vs, contains 3D geometric coordinates, {Xs, Ys, Zs} and 2d texture coordinates {Vx_s, Vy_s} in a global texture map, Mt.

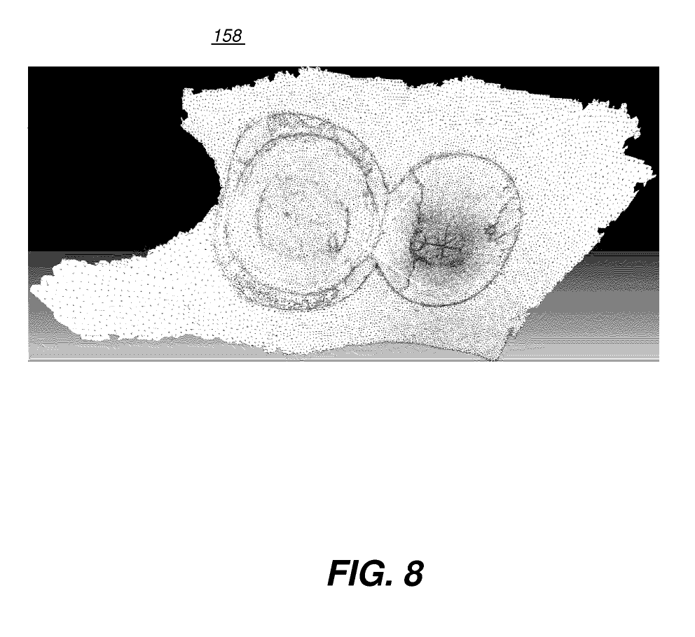

Mesh-parameterization sets up a parameter representation for Mo, in a 2D parameter-space, Po, if Mo is always locally homeomorphic to a disc. For each facet Fi in F of Mo, there is a corresponding 2d facet Tk corresponding to Fi. The full parameter space, Po, would include the facets set T={T1, T2, . . . , TL} and the vertices set U={U1, U2, . . . , Uo}. Any vertex Up in set U has 2D coordinate {Qx_p, Qy_p}. A result of mesh parameterization of a 3D surface is shown in FIG. 8.

Continuing with the FIG. 4 sequence, a mesh parameterization step S410 takes the 3D mesh and associated positional data for vertices and mesh faces as input and transforms the 3D mesh data to parametric 2D mesh data. FIG. 8 shows an exemplary parameterized 2D mesh 158 formed from the 3D mesh data.

After mesh-parameterization, an index image as a panorama of a textured surface of teeth is generated by the following sequence:
For each facet, Fi, in F, using the texture coordinates in Mt of all vertices of Fi, a polygon Hi can be generated in Mt. In the parameter space Po, there is also a 2D facet Ti corresponding to Fi. With the correspondence between Hi and Ti, a geometric transformation in the form of a matrix, in particular an affine transform, can be set up to describe the relationship between Hi and Ti. Then the image patch of Hi in the global texture map Mt can be warped into a new image patch using the geometric transformation. The acquired transformation can embed the new image patch into Ti. After processing each facet of the tooth surface in this way, a panoramic 2D index image is generated.

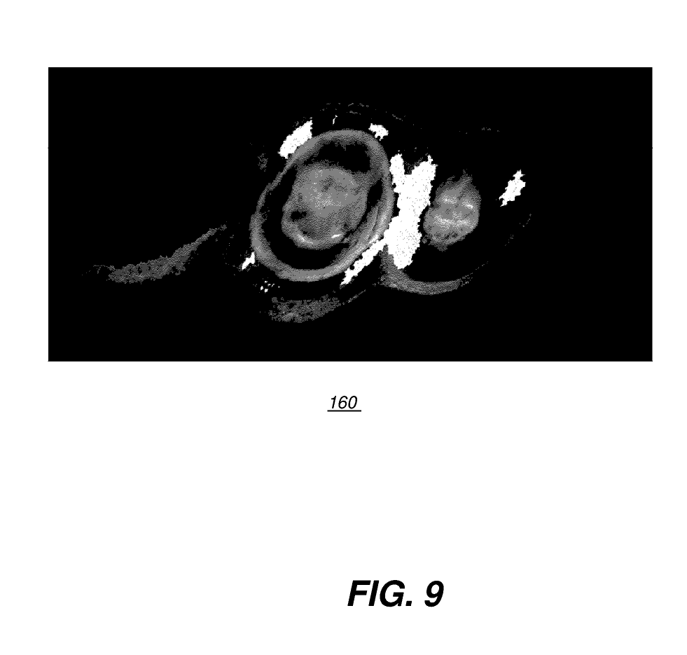

Still following FIG. 4, a 2D index image generation step S420 then generates an index image, also termed a panorama image, using the mesh parameterization from step S410 and reflectance image data from the camera. FIG. 9 shows a 2D index image 160 corresponding to a tooth surface 156 from the surface model M0, as shown in FIG. 7. The reflectance image data provides texture patches for the 3D facets of the surface model M0 mesh and for the corresponding 2D facets of the generated 2D index image. A display step S430 displays the 2D index image for viewer instruction entry that indicates the region of interest (ROI) of the image content that is needed for 3D display. Upon receiving viewer instructions, a response step S440 executes, in which processing identifies ROI content based on viewer instructions. A rendering step S450 then renders the specified ROI to the display, according to information content from surface model M0 and the global texture map.

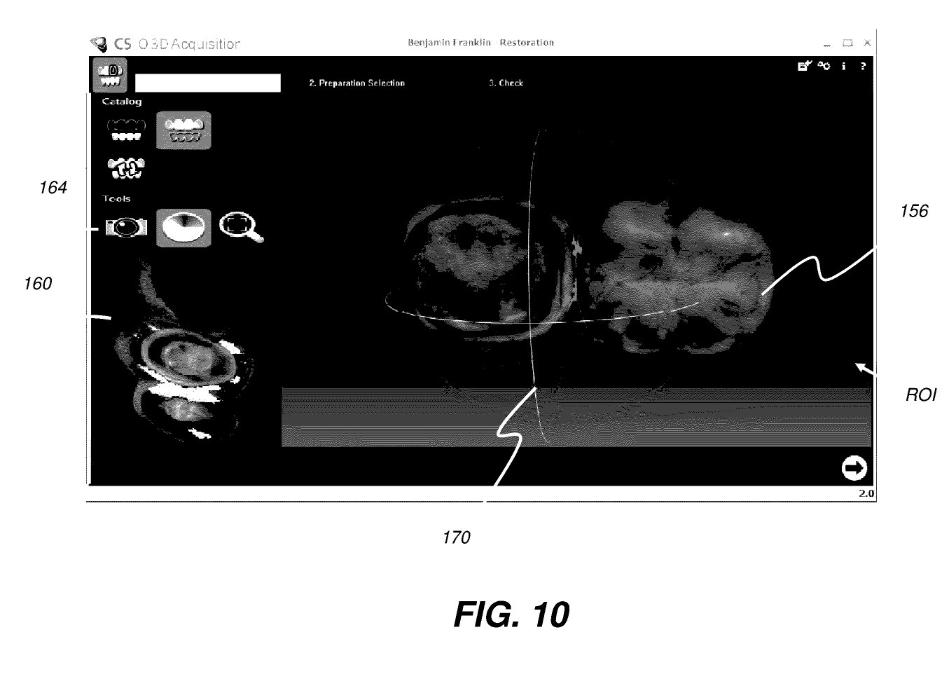

The exemplary display screen shown in FIG. 10 shows how 2D index image 160 generated using the FIG. 4 sequence can be used as part of an operator interface for specifying an ROI from tooth surface model M0 for display. 2D index image 160 displays on one part of the display, along with optional display utilities 164 that allow color selection, zoom, capture, and other useful capabilities. Tooth surface 156 from the tooth surface model M0 displays that portion of the surface model specified by the viewer using index image 160. The viewer can specify the ROI from index image 160 using any of a number of pointer controls, including a computer mouse pointer or a pointing mechanism provided as part of the operator interface for the imaging system, for example. Then the pixels in the ROI in index image 160 are mapped to 2D facets in the 2D parameterized mesh 158 in FIG. 8. The corresponding 3D facets on mesh 150 in FIG. 5 are identified. Modification of the ROI on the 3D model surface is then correlated with the corresponding content of the index image.

The 3D surface image view is initially rendered at a view angle that corresponds to the average view angle of the selected area of the ROI. Thus, for example, the average normal vector direction for each facet in the selected ROI is determined and used as the initial view angle for 3D rendering. Once the 3D rendered version of tooth surface 156 is displayed, a manipulable control, on-screen guide 170, displays, indicating the averaged normal vector and view angle with two crossed curves that can be rotated to left and right and up-down for changing the view angle.

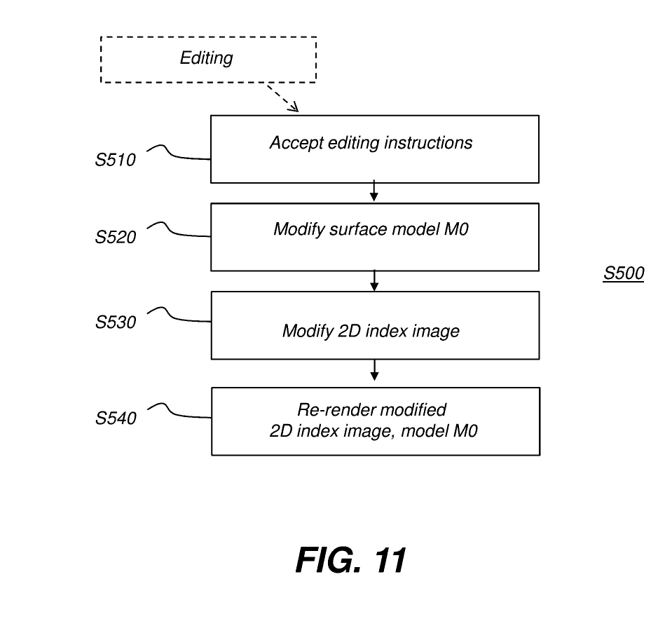

The logic flow diagram of FIG. 11 shows an editing sequence S500 that the computer processor executes with each edit that is performed by the practitioner or other editor. In an accept editing step S510, editing commands are accepted for execution by the processor. Editing commands can include commands that alter tooth shape or commands that provide a restorative treatment or procedure, including drilling, insertion of prosthetic devices, and other functions. In a modify model step S520, the editing commands change the 3D model. In a modify index image step S530, the index image is modified accordingly. Both the index image and the corresponding portion of the 3D model are then re-rendered for display in a re-rendering step S540.

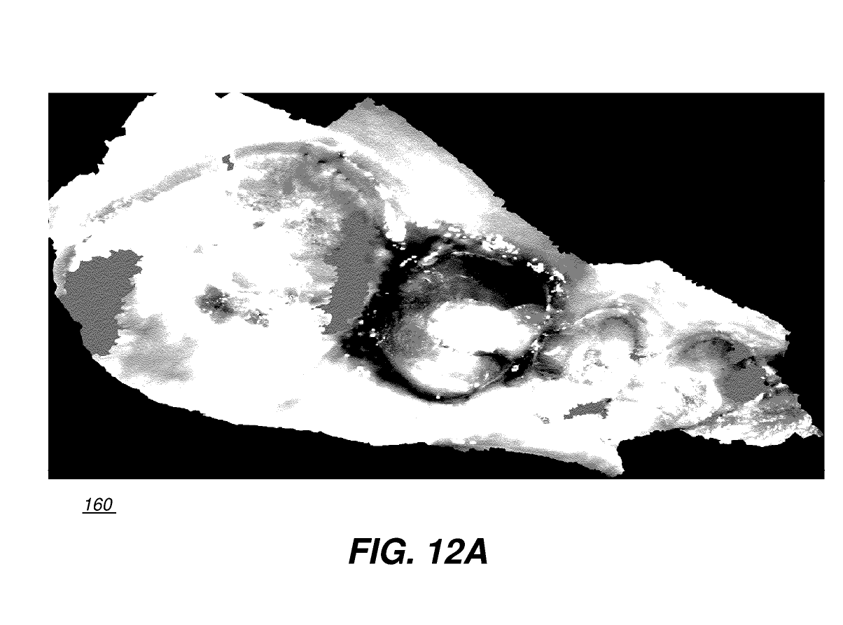

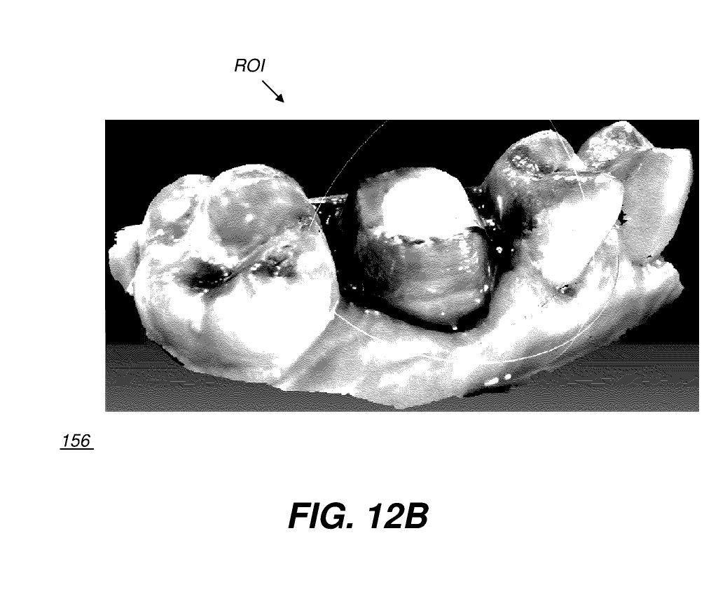

FIG. 12A shows a typical 2D index image for a portion of the dental arch. FIG. 12B shows a corresponding portion of tooth surface model M0 as rendered on the display screen by the system computer processor. As can be readily seen, the 2D index image may not be proportionally accurate and may have color content that represents only a portion of the 3D surface content.

Using an operator interface such as that shown with reference to FIG. 10 allows the practitioner to conveniently and quickly rotate, pan, displace, and otherwise manipulate only a region of interest (ROI) portion of the tooth model. This reduces the data processing and storage requirements for video contour imaging, while still allowing the operator to have a significant amount of control over displayed content.

It should be noted that the 3D volume image content can be from sources other than structured light images, including reflectance images of other types that can be used to generate a point cloud that is used for 3D mesh construction.

Consistent with an embodiment of the present invention, a computer executes a program with stored instructions that perform on image data accessed from an electronic memory. As can be appreciated by those skilled in the image processing arts, a computer program of an embodiment of the present invention can be utilized by a suitable, general-purpose computer system, such as a personal computer or workstation, as well as by a microprocessor or other dedicated processor or programmable logic device. However, many other types of computer systems can be used to execute the computer program of the present invention, including networked processors. The computer program for performing the method of the present invention may be stored in a computer readable storage medium. This medium may comprise, for example; magnetic storage media such as a magnetic disk (such as a hard drive) or magnetic tape or other portable type of magnetic disk; optical storage media such as an optical disc, optical tape, or machine readable bar code; solid state electronic storage devices such as random access memory (RAM), or read only memory (ROM); or any other physical device or medium employed to store a computer program. The computer program for performing the method of the present invention may also be stored on computer readable storage medium that is connected to the image processor by way of the internet or other communication medium. Those skilled in the art will readily recognize that the equivalent of such a computer program product may also be constructed in hardware.

It will be understood that the computer program product of the present invention may make use of various image manipulation algorithms and processes that are well known. It will be further understood that the computer program product embodiment of the present invention may embody algorithms and processes not specifically shown or described herein that are useful for implementation. Such algorithms and processes may include conventional utilities that are within the ordinary skill of the image processing arts. Additional aspects of such algorithms and systems, and hardware and/or software for producing and otherwise processing the images or co-operating with the computer program product of the present invention, are not specifically shown or described herein and may be selected from such algorithms, systems, hardware, components and elements known in the art.

In the context of the present disclosure, the act of “recording” images means storing image data in some type of memory circuit in order to use this image data for subsequent processing. The recorded image data itself may be stored more permanently or discarded once it is no longer needed for further processing.

It should be noted that the term “memory”, equivalent to “computer-accessible memory” in the context of the present disclosure, can refer to any type of temporary or more enduring data storage workspace used for storing and operating upon image data and accessible to a computer system. The memory could be non-volatile, using, for example, a long-term storage medium such as magnetic or optical storage. Alternately, the memory could be of a more volatile nature, using an electronic circuit, such as random-access memory (RAM) that is used as a temporary buffer or workspace by a microprocessor or other control logic processor device. Display data, for example, is typically stored in a temporary storage buffer that is directly associated with a display device and is periodically refreshed as needed in order to provide displayed data. This temporary storage buffer can also be considered to be a memory, as the term is used in the present disclosure. Memory is also used as the data workspace for executing and storing intermediate and final results of calculations and other processing. Computer-accessible memory can be volatile, non-volatile, or a hybrid combination of volatile and non-volatile types. Computer-accessible memory of various types is provided on different components throughout the system for storing, processing, transferring, and displaying data, and for other functions.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim.

While the invention has been illustrated with respect to one or more implementations, alterations and/or modifications can be made to the illustrated examples without departing from the spirit and scope of the appended claims. In addition, while a particular feature of the invention can have been disclosed with respect to one of several implementations, such feature can be combined with one or more other features of the other implementations as can be desired and advantageous for any given or particular function. The term “at least one of” is used to mean one or more of the listed items can be selected. The term “about” indicates that the value listed can be somewhat altered, as long as the alteration does not result in nonconformance of the process or structure to the illustrated embodiment. Finally, “exemplary” indicates the description is used as an example, rather than implying that it is an ideal.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims, and all changes that come within the meaning and range of equivalents thereof are intended to be embraced therein.

What is claimed is:

1. A method for display of a region of interest of a 3D tooth surface model, the method comprising:
forming the 3D surface model using a plurality of structured light images;
forming a global texture map for the 3D surface model according to a plurality of reflectance images of the teeth;
generating and displaying a 2D index image from the 3D surface model, wherein pixels in mesh elements of the 2D index image have corresponding surface facets of the 3D surface model; and
identifying and rendering the region of interest in response to viewer instructions.

2. The method of claim 1 further comprising re-rendering the region of interest in response to one or more editing instructions.

3. The method of claim 1 further comprising re-rendering the 2D index image in response to one or more editing instructions.

4. The method of claim 1 wherein forming the global texture map comprises mapping pixel locations to vertices in the 3D surface model.

5. A method for display of a region of interest of a 3D tooth surface model to a viewer, the method comprising:
forming the 3D surface model using a plurality of structured light images;
forming a global texture map for the 3D surface model according to a plurality of reflectance images of the teeth;
generating and displaying a 2D index image from the 3D surface model, wherein pixels in mesh elements of the 2D index image have corresponding surface facets of the 3D surface model;
accepting viewer instructions for modifying either or both the 3D surface model and the 2D index image according to a dental procedure; and
modifying the 2D image content and rendering the 3D region of interest in response to viewer instructions.

6. An apparatus for display of a region of interest of a 3D tooth surface model, the method comprising:
a camera that obtains reflectance images of a tooth and scanned contour images;
an image processor that is in signal communication with the camera and has a display and is programmed with instructions for executing a sequence of:
forming the 3D surface model using a plurality of structured light images;
forming a global texture map for the 3D surface model according to a plurality of reflectance images of the teeth;
generating and displaying a 2D index image from the 3D surface model, wherein pixels in mesh elements of the 2D index image have corresponding surface facets of the 3D surface model; and
identifying and rendering the region of interest in response to viewer instructions.
